(19) United States
(12) Patent Application Publication
(10) Pub. No.: US 2010/0131209 A1
(43) Pub. Date: May 27, 2010

(54) METHOD OF PREDICTING THE LOCATION OF MICROBIOLOGICALLY INFLUENCED CORROSION OF UNDERGROUND ITEMS

(76) Inventor: Michael L. Pacelli, Auburn, NY (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/323,043

(22) Filed: Nov. 25, 2008

(51) Int. Cl. G01N 17/00

(52) U.S. Cl. 702/35

(57) ABSTRACT

A method of predicting the location of microbiologically influenced corrosion (MIC) of underground items is disclosed. Soil criteria favorable for the growth of microbiological organisms involved with MIC are selected. Soil types are then selected that satisfy one or more of the selected soil criteria. Next, geographic areas are identified where the selected soil types are present. Finally, underground items are located in these identified areas containing the selected soil types. The method can involve validating the accuracy of the prediction by examining the landscape for vegetation indicative of the presence of the expected soil type, and culturing soil samples from areas predicted to have MIC and areas not predicted to have MIC, in order to compare the presence of microbiological organisms in each.

### BACKGROUND OF THE INVENTION

The present invention relates generally to microbiologically influenced corrosion of underground items, and more particularly to the prediction of the location of microbiologically influenced corrosion of underground items.

Corrosion, in general, is a leading cause of pipeline failures and resulting hazardous-liquid spills and accidents, causing environmental damage and significant financial losses. One of the causes of pipeline corrosion (both internal and external) is microbiologically influenced corrosion (MIC), which refers to corrosion that is influenced by the presence of microbiological organisms and the waste products secreted by their metabolism. In addition to causing corrosion of pipelines, MIC has also been identified as a source of corrosion of other items in modern industrial systems, including in power generation, oil production, chemical processing, transportation, the pulp and paper industries, and even the medical and dental fields with the advent of metal implants.

It is estimated that there are over two million miles of pipeline that lie underground in the United States, many miles of which are several decades old. With increasing age, there is a concomitant increase in the number of incidents caused by corrosion. Accordingly, monitoring and inspection of these pipelines are required to identify and repair pipelines experiencing corrosion prior to any resulting failure and accident. However, it is difficult, if not impossible, to employ enough inspectors and resources to monitor and inspect all of these pipelines.

U.S. Pat. No. 7,231,331 discloses a method and system to detect stress corrosion cracking (SCC) in pipeline systems. The disclosed method predicts the location of SCC in a steel gas pipeline segment under inspection by integrating three methods: 1) in-line smart tool inspection designed to detect external pipeline wall crack-like features; 2) in-line smart tool inspection designed to detect external metal loss corrosion anomalies; and 3) soil characterization and modeling to determine susceptible terrain for SCC. Notably, these three methods only provide information for segments of the pipeline actually inspected, offering no information for miles of pipeline that are not inspected.

The first two methods require the use of smart tools (or smart Pipeline Inspection Gauges (or PIGs)), which can contain various sensors, electronics, computers, and recording devices, to be sent down a pipeline that collect data about the pipeline that is later analyzed to determine the condition of the pipeline. For example, some smart tools inspect for corrosion using technologies such as magnetic flux leakage and ultrasonics. Smart tools are more accurate for inspecting the internal condition of pipe, but are less accurate for detecting external anomalies. In addition, the use of smart tools is expensive even for only inspecting a segment (rather than the entire) pipeline system and requires a team of technical experts. The third integrated method, soil characterization and modeling, requires a survey that is performed by walking the length of the pipeline segment to be inspected and periodically collecting a soil sample from pipeline depth with a hand auger. Once collected, the soil is tested for pH and the presence of chemicals known to be present where SCC has previously been found on pipelines. According to the patent, this third method (referred to as “near neutral/low pH SCC detection”) suffers from several disadvantages, including the fact that it is costly, highly labor-intensive, and often yielded false or inconclusive results. Possible explanations for the lack of accuracy of the patent's soil characterization and modeling is that the analysis of the soil characterization data focuses on no specific or root cause of corrosion, but merely identifies potentially corrosive soil types by correlating them with documented past corrosion. In doing so, the method fails to obtain a high degree of verisimilitude between identified corrosive conditions and actual corrosive conditions. Furthermore, there is less likelihood the method can be transferred accurately from one geographical location to another geographical location with different soil types. The success depends, in large part, on a sufficient level of available pipeline corrosion data for the different soil types in the other location. If the records are insufficient, then this method of soil characterization cannot be relied upon at all.

Accordingly, it would be advantageous to develop a cost-effective method of identifying and predicting which underground items (e.g., certain segments of underground pipelines) are more susceptible to MIC in order to more accurately identify those segments that should be subjected to inspection. Furthermore, it would be advantageous if the method was based primarily or solely on knowledge of geographic factors directly promoting MIC, without relying primarily on subjective opinion, history of failure, or direct inspection of the item for corrosion.

### BRIEF DESCRIPTION OF THE INVENTION

A method of predicting the location of MIC of underground items is disclosed. In one embodiment, the method comprises the steps of selecting soil criteria favorable for the growth of microbiological organisms that cause MIC, selecting soil types that satisfy one or more of the selected soil criteria, identifying areas where the selected soil types are present on a geographical information systems map, and identifying underground items located in the identified areas.

### BRIEF DESCRIPTION OF THE DRAWINGS

FIG. 1 is a flow diagram for the method of predicting the location of MIC of underground items in one embodiment of the invention.

FIG. 2 is a prediction map for predicting the location of MIC of underground items in one embodiment of the invention.

### DETAILED DESCRIPTION OF THE INVENTION

The present invention is an example of an environmental risk assessment model. This particular model deals with the potential adverse effects of MIC to underground items. The prediction of the locations of MIC would allow for a more accurate identification of those areas of underground items that may require a closer inspection, allowing more focused and less costly maintenance. In one embodiment of the invention, a method is disclosed to develop a prediction map for predicting the location of MIC of underground pipelines. The disclosed embodiment uses geographical information systems (GIS) as tools to help develop the environmental risk assessments as associative prediction maps. GIS can be used to create site-specific prediction maps to characterize and identify high risk areas to such things as maintenance of underground pipeline systems.

In addition to pipelines, the disclosed method works similarly well regarding other underground items including, but not limited to, storage tanks, electric cables, pilings, utility poles, water pipelines, sewage pipelines, drain pipelines, building foundations, drilling rigs, cropping, and placement of caskets in cemeteries. Accordingly, the disclosed method could be employed in many industries, including but not limited to power generation, oil production, chemical processing, transportation, the pulp and paper industries, and the medical and dental fields.

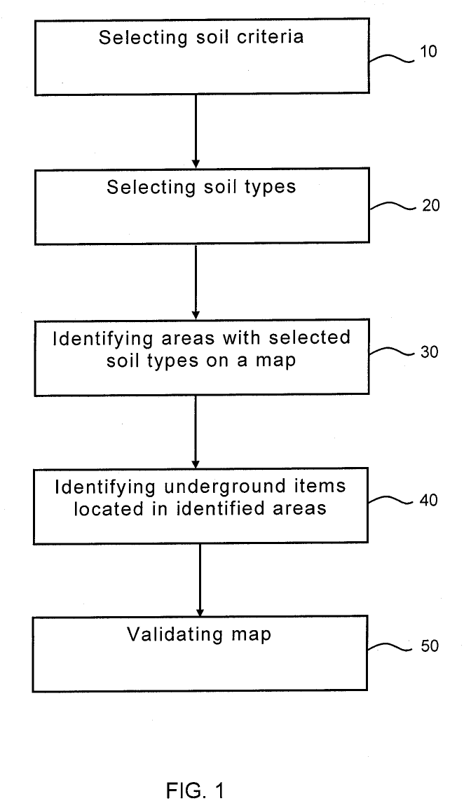

In one embodiment of the invention, as illustrated by FIG. 1, the following steps can be employed in the method of predicting the location of MIC of underground items: (1) selecting soil criteria favorable for the growth of microbiological organisms that cause MIC 10; (2) selecting high risk soil types that satisfy one or more of the selected soil criteria 20; (3) identifying areas at high risk for MIC on a map based on the presence of the selected high risk soil types in those areas 30; (4) identifying underground items installed in those high risk areas 40; and (5) validating the accuracy of the prediction map 50.

As shown in FIG. 1, the first step 10 is selecting soil criteria (i.e., physical and chemical characteristics of soil) favorable for the growth of microbiological organisms that cause MIC. The potential for MIC is controlled by the availability of nutrients, water, and electron acceptors. All microbiological organisms that cause MIC need water, a source of energy, a carbon source, an electron donor, and an electron acceptor. Nutrients, especially organic nutrients, which are in short supply in most aquatic environments, are absorbed on surfaces, including metals, creating areas for growth. Microbiological organisms able to find and establish themselves at these sites will have a distinct advantage in such environments.

Not all microbiological organisms influence corrosion. Taxonomists have grouped microbiological organisms into three major domains: (1) Bacteria, (2) Archaea, and (3) Eukarya. Members of the Eukarya are subdivided into four kingdoms: Protista, Fungi, Plantae, and Animalia. Most microbiological organisms that cause MIC belong to the Bacteria and Archaea domains. A few fungi, belonging to the Eukarya domain, have also been isolated from biofilms that cause corrosion. Some examples include acid producing fungi, aerobic slime formers, iron/manganese oxidizing bacteria, methane producers, organic acid producing bacteria, sulfate reducing bacteria, and sulfur/sulfide oxidizing bacteria. These microbiological organisms coexist in naturally occurring biofilms often forming communities able to affect electrochemical processes through cooperative metabolism which individual species have difficulty initiating.

Soil criteria favorable for the growth of microbiological organisms can be selected by considering an area's topography and climate, and the potential for the growth of certain types of microbiological organisms that might thrive there. Generally, wet, low lying, poorly aerated soil types tend to provide sites for the growth of soil microbiological organisms. Anaerobic bacteria, for instance, thrive in waterlogged, dense soil. Alternating moisture and oxygen concentrations will influence the growth of bacterial populations. In general, high clay soil types support populations of sulfate-reducing bacteria. Generally, course sandy soil types with a low water-holding capacity drain and aerate well, and do not provide a good environment for microbial growth. On the other hand, clay and silty soil types have a high water-holding capacity, tending to give them poor drainage and poor aeration, which is generally desirable to microbiological organisms. However, variations in soil criteria can be selected depending on the geographic area and types of microbiological organisms abundant in the area that are associated with MIC.

In one embodiment, the first step 10 of selecting the soil criteria favorable for the growth of microbiological organisms that cause MIC can include referencing or consulting current scientific literature, knowledge, and records to identify the relevant criteria. Examples of soil criteria that are favorable for the growth of microbiological organisms that cause MIC are: (1) Corrosive to Uncoated Steel, (2) Hydric, and (3) Clay Texture. Other soil criteria encouraging microbial growth can be used to select high risk soil types as well.

Referring again to FIG. 1, the next step 20 after the selection of soil criteria is selecting soil types that satisfy one or more of the selected soil criteria. In one embodiment, the step 20 of selecting soil types can be done by querying a geographic database that contains physical and chemical characteristics for several soil types to identify which soil types satisfy one or more of the selected soil criteria (i.e., those characteristics that are favorable for the growth of microbiological organisms that cause MIC). An example of a geographic database that can be used is the USDA Soil Survey Geographic Database (SSURGO), which contains physical and chemical characteristics for approximately 18,000 soil series recognized by the United States. Other databases may be used in addition to, or in replacement of SSURGO. The selection of these high risk soil types can also be done by collecting soil samples of soil types. The physical and chemical characteristics of the soil samples can be compared to the selected soil criteria to determine if they are high risk soil types. For example, high risk soil types can be high in soluble salt, high in moisture, and low in oxygen.

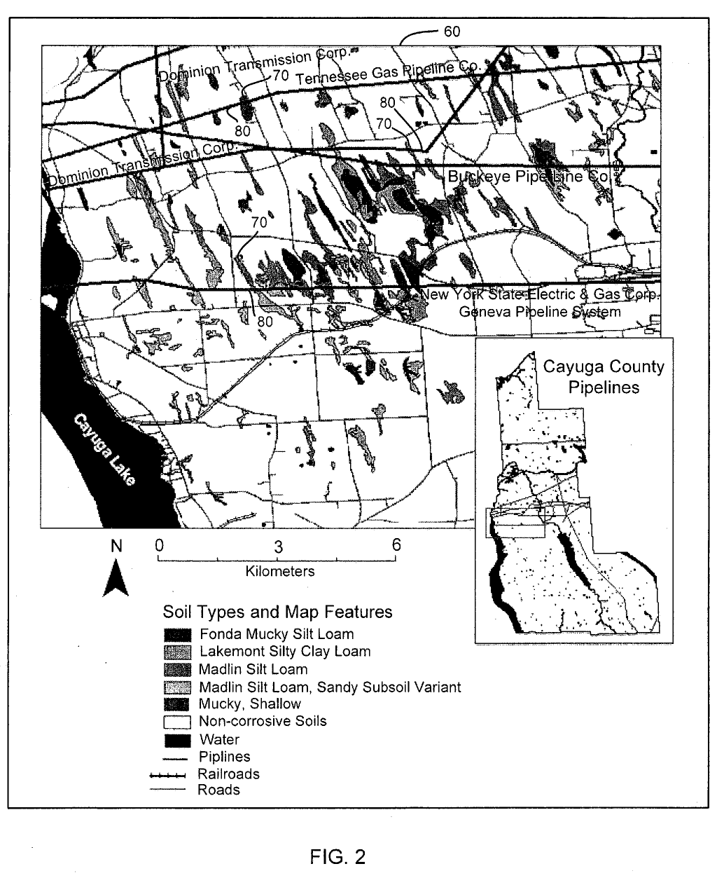

Referring again to FIG. 1, once the high risk soil types are selected, the next step 30 is to use this information to identify areas at high risk for MIC on a map based on the presence of the selected high risk soil types in those areas. An example of such a prediction map is shown in FIG. 2 as a map created with GIS software. In the exemplary prediction map shown in FIG. 2, spatial data (e.g., identification of the coordinate system used and the relevant boundary coordinates) in the form of colored or shaded polygons are used to identify the areas 70 where the high risk soil types are present on the map. This spatial data can be stored in a shapefile (e.g., line shapefile, polygon shapefile, or polyline shapefile). Spatial data for other map features such as roads, railroads, and boundaries can be added to facilitate comparing map features to surface observations (ground truthing). In one aspect of the invention, a user can be given the option to choose which features are to be displayed on the prediction map.

Referring once again to FIG. 1, once the areas 70 at high risk for MIC have been identified, the next step 40 is to identify underground items (e.g., pipelines) 80 installed in the high risk areas 70 and, therefore, exposed to the high risk soil types, as at risk for MIC. Spatial data can be used to identify the location of these underground items on the prediction map. In FIG. 2, pipeline segments 80 intersecting the colored or shaded polygons indicating high risk areas 70 are at risk of MIC.

Continuing with FIG. 1, the prediction map can be validated with empirical data to determine the accuracy of the map 60, which is based on the spatial data which determined the areas and locations of the high risk soil types and the underground items (e.g., pipelines). One method of validation is to visually inspect the vegetation in the high risk areas to confirm that it is of the type that would be expected for the particular high risk soil type. Another method of validation is sampling soil from areas where high risk soil types should be found according to the map as well as areas where the high risk soil types should not be found according to the prediction map and then tested for the enumeration and identification of microbiological organisms that cause MIC. If the prediction map is accurate, the soil samples collected from the predicted high risk soil type areas will statistically show a greater presence of microbiological organisms that cause MIC than the other areas. In order to make this determination, the collected samples can be cultured for the presence of the microbiological organisms that cause MIC.

Enumerations of microbes from the predicted areas of high risk soil types can be statistically analyzed to determine if microbial counts are significantly different from other soil types. To control the effects of outside variables, cultures of microbes can also be taken from commercially available samples of the same soil types. To determine if the predicted high risk soil types have a significantly greater number of MIC-related microbes compared to the low risk soil types, statistical methods that enumerate different aspects of goodness of fit can be used, such as the t-distribution, Analysis of Variance (ANOVA), Chi-square test, factor analysis, the Kolmogorov-Smimov test, Student's t-test, single factor ANOVA, nonparametric tests, regression analysis, and spectral analysis.

To determine the species of microbes in the high risk areas, soil samples taken from the high risk areas can undergo microbial identification by a method such as Fatty Acid Methyl Ester (FAME) profiling by gas chromatography. The Sherlock® Microbial Identification System, developed by MIDI Inc., of Newark, Del. can identify over 1,500 bacterial species based on gas chromatography analysis of fatty acid methyl esters (FAME). FAME analysis has benefits due to its accuracy and costs. However, other methods of identification can be used. The BHIBA database can be used to identify anaerobic bacteria. BHIBA is a library of 10,000 stored fatty acid chromatograms of anaerobic bacteria from around the world.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of predicting the location of microbiologically influenced corrosion (MIC) of underground items comprising the steps of:
selecting soil criteria favorable for the growth of microbiological organisms that cause MIC;
selecting soil types that satisfy one or more of said soil criteria;
identifying areas where said soil types are present on a geographic information systems map; and
identifying said underground items located in said areas.

2. The method of claim 1, wherein said step of identifying said underground items located in said areas comprises the step of identifying said underground items on said geographic information systems map.

3. The method of claim 1, wherein said step of selecting soil types comprises the steps of:
collecting soil samples; and
comparing characteristics of said soil samples to said soil criteria.

4. The method of claim 1, wherein said step of selecting soil types comprises the step of querying a geographic database that contains physical and chemical characteristics for a plurality of soil types to identify which soil types satisfy one or more of the said soil criteria.

5. The method of claim 4, wherein said geographic database is a USDA Soil Survey Geographic database.

6. The method of claim 1, further comprising the step of validating the accuracy of said identification of said areas where said soil types are present on a geographic information systems map.

7. The method of claim 6, wherein said step of validating comprises a visual inspection of the vegetation in said areas to confirm that it is of the type that would be expected for said soil types.

8. The method of claim 6, wherein said step of validating comprises the steps of:
collecting soil samples from said areas;
collecting soil samples outside of said areas;
culturing said samples for said microbiological organisms that cause MIC;
counting the number of said microbiological organisms that cause MIC in said samples; and
determining whether the number of microbiological organisms that cause MIC in said samples from said areas is significantly different than the number of microbiological organisms that cause MIC in said samples outside said areas.

9. The method of claim 1, wherein the underground items are pipelines.
